(19) United States
(12) Patent Application Publication
(10) Pub. No.: US 2024/0109515 A1
(43) Pub. Date: Apr. 4, 2024

(54) ICE AND SNOW WARNING AND REMOVAL FOR ELECTRIFIED VEHICLES

(71) Applicant: FORD GLOBAL TECHNOLOGIES, LLC, Dearborn, MI (US)

(72) Inventors: Brendan F. Diamond, Grosse Pointe, MI (US); Adam D. Deibler, Plymouth, MI (US); John R. Van Wiemeersch, Novi, MI (US); Ryan E. Hanson, Livonia, MI (US); Stuart C. Salter, White Lake, MI (US)

(21) Appl. No.: 17/959,437

(22) Filed: Oct. 4, 2022

(51) Int. Cl. B60S 1/02; B60S 1/56

(52) U.S. Cl. CPC B60S 1/026; B60S 1/56

(57) ABSTRACT

A snow and ice vehicle accumulation determination and removal system for an electrified vehicle uses weight/load estimation methods based on vehicle sensors and user input to determine if the vehicle has accumulated a significant amount of snow/ice that could negatively affect the vehicle range. When a weight variation exists above a predetermined threshold which can be accounted for only as being due to snow and ice, then the invention may (1) warn the driver of reduced range and the reason for it, (2) perform drivetrain and/or cabin heating that may contribute to melting of the snow and ice (e.g., automatically adjusting powertrain performance to generate increase heat, such as running at a higher RPM), and/or (3) instruct the driver to proceed to an environment which can warm the vehicle (such as a facility equipped with a hot water spraying device).

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to electrified vehicles such as battery-driven electric vehicles and hybrid vehicles, and, more specifically, to monitoring electrified vehicles for accumulated ice and snow and initiating actions to remove the ice and snow when added weight of the ice and snow impairs a driving range of the vehicle.

While driving in cold conditions when there has been precipitation, frozen water in the form of ice and/or snow may accumulate on many parts of the vehicle (e.g., by directly falling on the upper surfaces of the vehicle or sticking to the wheels or underbody during driving). Added weight of ice/snow being carried by the vehicle results in reduced range and performance. For a passenger vehicle or a pickup truck, an added weight can easily amount to 850 lbs. which may result in a range decrease of about 10-15%. Since an electrified vehicle in cold conditions may already be subject to a decreased usable battery energy (e.g., since a battery capacity for a specific normalized discharge rate may drop at lower temperatures), and since battery drain may be increased because of higher HVAC loads for warming the interior passenger cabin, any additional decrease in range due to the additional weight of ice/snow may be particularly undesirable (especially since the vehicle driver may not realize the presence or implications of the added weight).

### SUMMARY OF THE INVENTION

The present invention provides a snow and ice vehicle accumulation determination and removal system. Weight/load estimation methods based on vehicle sensors and user input are employed to determine if the vehicle has accumulated a significant amount of snow/ice that could negatively affect the vehicle's performance and range. User assistance may be provided to automatically or manually remove the snow/ice.

Features of the invention may be auto-enabled based on weather conditions. For example, whenever an ambient temperature sensor of the vehicle measures a temperature that indicates snow precipitation is possible or that snow/ice could exist on the roadway or on the vehicle then monitoring may be initiated to detect the actual presence of an added weight from ice and snow. In some embodiments, a rolling average of the ambient temperature covering a period of days in which snow/ice accumulation has occurred can be utilized to project whether snow/ice was unable to melt due to the ambient temperature remaining sufficiently close to freezing. A is historical log can be tracked based on the GPS locations of the vehicle throughout the rolling average window. The presence of snow/ice can also be determined using vehicle exterior cameras. An amount of expected snow derived from weather forecasts can also be used to more reliably track a snow accumulation event as it occurs.

To detect incremental weight from ice/snow accumulation, the invention may perform general monitoring of the vehicle weight during times before the potential for ice/snow accumulation (e.g., vehicle weight can be sampled on a routine basis when it is known that no snow or ice will be present). A weight estimation method may preferably characterize the mass of the vehicle, cargo contents of the vehicle, and any additional mass being propelled by the vehicle (e.g., a trailer). Total weight may be estimated on every key (ignition) cycle and refined continuously while the vehicle is driving (i.e., capturing vehicle weight together with the gear and occupants inside). A moving average type of measurement can be used to compare vehicle weight before and after each drive event. Discrete weight changes can be attributed to cargo and/or occupants entering or exiting the vehicle. Vehicle weight can be measured using on-board scales or ride height sensors, or can be estimated using known methods based on measured vehicle acceleration, commanded wheel torque, or vehicle pitch (IMU). The weight determination can be made with reference to a known factory vehicle weight and whatever add-ons are installed on the vehicle. Add-on weight (e.g., snow-plow or truck bed tool-box) can be estimated by onboard scales or user input. Add-on weight will likely be discrete events (e.g., sudden change of 200 lbs.) and are easily separated from accumulation-based events.

Vehicle weight may be estimated while occupants are in the vehicle and/or when the occupants have left the vehicle (e.g., as determined by an interior camera or a key-off based timer). Preferably, weight estimations continue to occur during a snow/ice accumulation event regardless of whether the vehicle is being driven. The two main kinds of conditions when a vehicle can gain weight due to ice/snow accumulation are (1) while the vehicle is driving and frozen or nearly frozen water is kicked up under the vehicle, and (2) when the moving or parked vehicle is snowed is upon during a precipitation event. In addition to the above methods, a snow/ice accumulation event can be detected as a result of (1) excessive or continuous traction control activation during normal driving while at a low ambient temperature, (2) an indication obtained using data from a weather communication system which may signify that the vehicle is in a location where a large snow event occurred recently or is occurring presently, (3) data from vehicle exterior cameras being processed using artificial intelligence and or machine learning (AI/ML) to recognize snow in front of the vehicle while driving, (4) images from a camera (e.g., located in a center high-mounted stop light module) detecting the presence of snow/ice in a truck bed, or (5) user input regarding the vehicle being driven in the snow or being set to a drive mode which indicates the presence of snow/ice.

Depending on the weight estimation technique being employed, the vehicle may use interior/exterior cameras to identify or estimate occupant and cargo object weight present in the vehicle based on sensor measurement and order of ingress into the vehicle (e.g., weight changes will be discrete and easy to identify). User input can provide additional information regarding the weight of objects or people, or load measurement devices can be used. In some situations, the weight of snow from a fresh downfall may be greatest on the Top-Hat surfaces of the vehicle (e.g., hood, roof, decklid) rather than on the undercarriage. It such situations, the user may clear the Top-Hat surfaces after starting the vehicle or by letting it run for a while (e.g., using remote start). As such, the weight estimation can be deferred one or two key cycles or can be set to occur later after a predetermined number of miles have been driven to allow for the possibility of the user clearing of Top-Hat snow and/or the snow being cleared by road movement or wind.

Over time, new weight estimations are compared to previous estimates. If a new weight is above a predetermined threshold (e.g., 300 lbs.) over the normal baseline weight of just the vehicle and its driver, then the user can be prompted to provide input regarding what the vehicle is carrying and whether a trailer is connected. Interior cameras, radar occupancy sensor, seat weight sensors, seat buckle status sensors, or direct user input can be used to determine the number of occupants in the is vehicle and an occupant's weight. If the vehicle ambient temperature sensor indicates that it has been in a heated climate (e.g., a garage) for an extended duration of time recently, this invention will deactivate as the snow/ice is likely not causing any significant increase in mass.

When appropriate, the invention advises a user/driver that action may be required to remedy an unnecessary loss of driving range due to the weight of snow and ice. For example, when a weight variation exists above a predetermined threshold which can be accounted for only as being due to snow and ice, then the invention may (1) warn the driver of reduced range and the reason for it, (2) perform drivetrain and/or cabin heating that may contribute to melting of the snow and ice (e.g., automatically adjusting powertrain performance to generate increase heat, such as running at a higher RPM), and/or (3) instruct the driver to proceed to an environment which can warm the vehicle until the ice and snow are melted. The instructions can include an identification of an available facility nearby which can provide the warming environment (e.g., a garage or a car wash or other facility having a hot water sprayer or radiant heaters to apply heat directly to the accumulated snow and ice). A suggested duration of heating can be included in the instructions based on ambient temperature conditions and estimated mass of the snow/ice accumulation. In the event of a short trip or a longer trip during which the accumulation occurs shortly before reaching a destination, the instructions to the user may suggest storing the vehicle inside a garage until the added vehicle weight estimation has returned to an acceptable level. In some embodiments, the user may be requested to provide visual confirmation that snow/ice has accumulated on the vehicle as a verification.

In some embodiments, the vehicle may include heat sources configured to supply energy for melting the ice and snow and/or the operation of ordinary powertrain components can be adjusted to generate excess heat energy. Supplemental heating devices may include a PTC heater or a heat pump. In an example of a modified operation, drive currents can be injected to a traction motor of an electrified vehicle as a Direct Axis current to heat up the motor without generating output torque (which may melt accumulated snow and ice on the motor itself and on nearby is structures).

Operational conditions of an expected vehicle usage in the current and short-term future environmental conditions can be used to determine if vehicle components carrying ice and/or snow will reach temperatures that would melt the frozen water without any need for other mechanisms to heat the vehicle. For example, if an electric truck is towing at a maximum load up a steep grade, its high voltage battery pack may reach 40° C. while its motor drive units may reach over 80° C. (which can quickly melt much of the snow or ice). Metrics to consider in making this determination include (a) an estimated time various components can remain at melting temperatures, (b) combined weight of the vehicle and its payload, (c) a thermal mass of the impacted vehicle components, (d) an estimate of snow/ice on vehicle, (e) ambient environmental conditions, and (f) vehicle speed. Ambient conditions can be obtained from an offboard weather forecast, for example. Looking one or more days into the future can be used to determine whether the snow or ice accumulated on the vehicle will melt naturally or if other types of heating are needed. Based on the estimated weight of the snow and ice, and how that extra weight affects vehicle range (e.g., normalized as a percentage of expected range), the invention can provide additional recommendations to the user to have the vehicle undergo supplemental heating. For a loss of driving range of about 2% to 5% (i.e., a zone of impairment corresponding to light accumulation of ice or snow), a warning message of “Please store vehicle indoors for X minutes or wash car undercarriage in hot water at your earliest convenience” can be used. For a loss of driving range of about 10% to 15% (i.e., a zone of impairment corresponding to heavy ice accumulation), a warning message of “Place vehicle in a heated environment or dealership to prevent significantly reduced range and/or vehicle damage” can be used.

In some embodiments, automatic actions may be taken. When the electrified vehicle is fully autonomous, the vehicle can drive itself to the heated environment (e.g., garage) even when it is being used for an extended period to better prepare the vehicle for driving. When the vehicle is stationary during charging of its battery pack and no occupants are in the vehicle, available current from a charger can is be applied to generate heat in the electric traction motors, battery pack, or other vehicle components. When the electrified vehicle has a hybrid powertrain, a combustion engine can use pull-up/pull-down logic to keep the engine running most of the time to promote heat generation. The electrified vehicle can also be instructed to automatically perform high levels of friction braking to help melt the snow/ice around the rotors and calipers of the brakes.

Fully autonomous or self-driving modes or operation of the vehicle (e.g., autonomous auto parking/valet service and/or remote-park features) may also use data to (1) determine whether weather/temperature conditions (e.g., sunny skies or above 0° C.) would assist in clearing accumulation weight, or (2) determine the prospect of further accumulation, and to automatically park or re-park the vehicle accordingly. For example, a parking spot may be selected in a sunny or warm area versus a spot in a parking structure lower level which would retain cooler temperatures longer. In some embodiments, custom areas in a parking structure or other parking facilities vehicles may be configured to foster the melting of accumulations of snow and ice off of vehicles, and an autonomous vehicle may be programmed to seek out these designated locations.

During charging, a cabin climate control of the vehicle can also be activated to help melt ice and snow to restore the best driving range without reducing the State of Charge of the battery pack. While heating and in subsequent vehicle usage, the vehicle mass can be estimated to determine if and how much additional heating should be used and to determine if the chosen heating methods are effective.

In a preferred embodiment, instructions for alerting the user may include specific advisories on how to take action. For example, Vehicle-to-Infrastructure (V2I) or other wireless communication can be used to determine locations of nearby facilities such as car washes, charging stations, or dealerships that are configured to wash underneath the vehicle with a direct spray application of hot water able to melt the snow and ice. For example, a specific station can be set up at a car wash dedicated to spraying down vehicles having adhered snow and ice. A database can provide locations of washing services with a preferred (e.g., certified) set of heating is capabilities that are specialized to specific vehicle models (e.g., battery electric vehicles or others). A vehicle manufacturer or other authority could grant certifications to facilities that meet certain requirements.

The length of time that the undercarriage is sprayed, the nozzle spray pattern, the locations for the spray to be focused on, and the temperature of the applied water can each be controlled to ensure that snow and ice are completely removed. During development of individual vehicle models, an identification of locations where snow or ice may tend to accumulate can be stored on the Cloud and/or in a vehicle electronic controller so that the information can be used to help focus the spray of hot water. Typical lengths of time for melting snow/ice from the particular vehicle models can also be empirically derived during vehicle development according to ambient temperatures and water spray temperatures and then stored for recall when clearing a vehicle of frozen water. In addition, evaluation of the weight distribution using ride height sensors, weight sensors, or other load estimates can be used to determine where the snow and ice are likely located in order to direct the hot water spray or other remediation. Further monitoring can be used to validate melting (i.e., that the vehicle has returned to a normal ride height or weight).

The invention may further include an analysis of what would be the most cost-effective means of removing the snow and/or ice (e.g., one having the least impact on the maximum driving distance under battery power). Potential choices include continued driving with the accumulated snow/ice, activating undercarriage heaters using vehicle battery power, or stopping and re-charging the electrified vehicle (EV) systems while powering the vehicle undercarriage heaters using an off-vehicle power source (e.g., 120V/240V plug-in recharging source or a wireless power system).

The invention may be useful even when various systems or materials are employed which can reduce the ability of snow and ice to accumulate on a vehicle. For example, movable surfaces, bladders, rollers, or other controlled items can be deployed under a flexible surface covering the exposed areas of a vehicle undercarriage to dislodge adhering snow and ice. In some systems, certain types of is materials can be used on exposed vehicle components to prevent or break up accumulations before they become too large for easy melting.

In one aspect of the invention, a method of operating an electrified vehicle includes monitoring the electrified vehicle to determine a baseline weight which is propelled by the electrified vehicle. An ambient temperature is determined to which the electrified vehicle is exposed. If the ambient temperature is less than a predetermined temperature threshold then an environmental assessment is performed to determine whether the electrified vehicle is subjected to accumulation of frozen water. If the electrified vehicle is subjected to accumulation of frozen water then (A) a frozen water weight carried by the electrified vehicle in excess of the baseline weight is estimated, (B) a range impairment according to the estimated frozen water weight is estimated, (C) if the estimated range impairment is in a first zone of impairment then a mild warning is provided to a user of the electrified vehicle indicating a first loss of driving range due to the frozen water weight, and (D) if the estimated range impairment is in a second zone of impairment greater than the first zone of impairment then (i) a facility is identified which is configured to supply energy which melts the frozen water and (ii) an urgent warning is provided to the user indicating a second loss of driving range due to the frozen water weight and suggesting that the electrified vehicle visit the identified facility.

### BRIEF DESCRIPTION OF THE DRAWINGS

FIG. 1 is a schematic diagram showing a vehicle and offboard resources for an ice and snow monitoring and removal system.

FIG. 2 is a time plot of a gross vehicle weight prior to and during an ice and snow accumulation event.

FIG. 3 is a schematic diagram showing a facility such as a garage or a car wash with devices for melting ice and snow and for recharging an electrified vehicle.

FIG. 4 is a flowchart showing one embodiment of a method of the invention.

FIG. 5 is a plot showing reduction of a range impairment as accumulated is ice and snow is melted.

FIG. 6 is a route diagram comparing a planned route to a destination and a detoured route which includes access to a facility capable of melting the ice and snow to reduce a range impairment.

FIG. 7 is a flowchart showing another embodiment of a method of the invention.

### DETAILED DESCRIPTION OF PREFERRED EMBODIMENTS

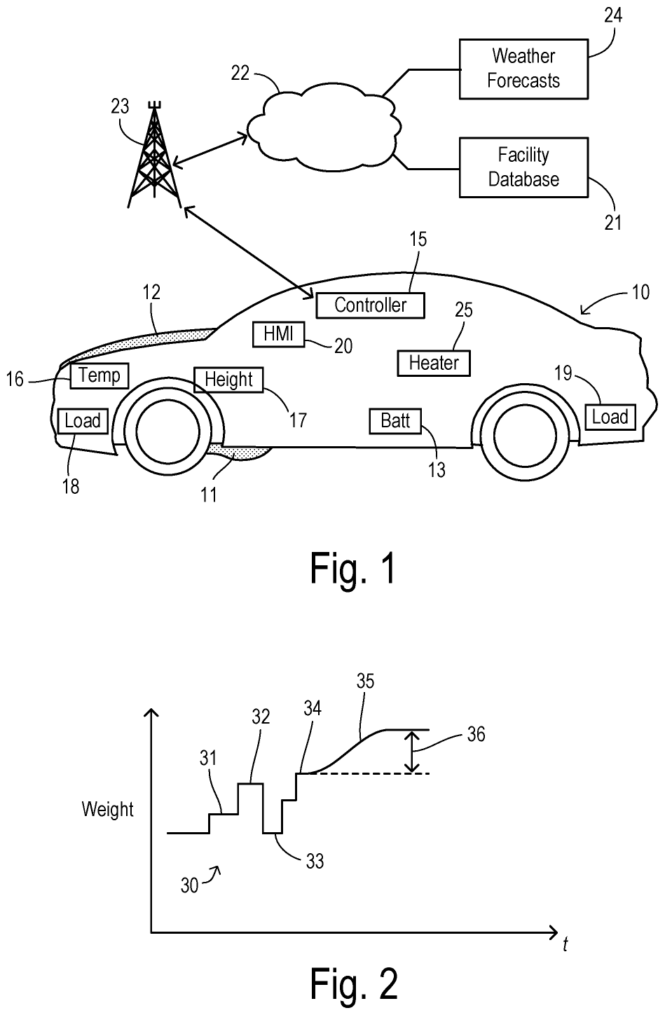

Referring to FIG. 1, an electrified vehicle 10 is shown with an accumulation of ice/snow 11 on its undercarriage and an accumulation of ice/snow 12 on a top-hat surface (e.g., an engine compartment hood). Vehicle 10 is powered by an electrical storage battery pack 13 with a limited capacity which determines an available driving range before recharging is necessary (or when operation of an internal combustion engine is needed in the case of a hybrid vehicle). A controller 15 is configured to monitor for a weight of accumulated frozen water and to provide suggested actions or perform automatic mitigations when the weight becomes excessive.

Controller 15 monitors various conditions using a suite of sensors and onboard and offboard data sources. The suite of sensors may include an ambient temperature sensor 16, a ride height sensor 17, and load sensors 18 and 19 associated with respective wheel suspensions. A human-machine interface (HMI) 20 such as a touchscreen display panel or a voice recognition system is provided for obtaining user input (e.g., obtaining confirmation from a driver whether there is a buildup of snow or ice, details about cargo loads or presence of a trailer, and/or a destination or route for a current drive cycle) and/or user commands or preferences. Controller 15 may contain electronic memory for storing supporting data such as all or a part of a facility database which identifies locations and capabilities of facilities for removing accumulated snow and ice. Offboard resources may include a facilities database 21 (as a replacement for or an extension of onboard memory) located on a server connected to a cloud network 22 reachable over a wireless service 23 such as a is cellular data connection. Another offboard server 24 may include weather forecast information which can be used to identify or predict freezing conditions as described below.

Electrified vehicle 10 may include an onboard heater 25 configured to heat areas of vehicle 10 where the snow and ice may be adhered. Heater 25 may be activated to remove the weight associated with the snow and ice, especially if the energy consumed by heater 25 is less than the energy that would be lost by propelling the weight of the snow and ice. Vehicle 10 may also have a capability to use other vehicle systems to generate excess heat for melting ice and snow, such as operating power converters, inverters, or electric motors/generators in a mode which increases the operating temperature of their electrical components.

FIG. 2 shows a plot 30 of a changing vehicle weight as the electric vehicle is driven over multiple drive cycles. For purposes of detecting a weight of frozen water being accumulated on the vehicle, a baseline weight of the full vehicle load excluding only such frozen water weight is tracked. The baseline weight includes all the mass being intentionally propelled (i.e., transported mass) including a weight of the vehicle itself, weight of vehicle occupants, weight of cargo payloads, and weight of any towed (i.e., trailered) vehicles. For distinguishing between the intended loads and accumulation of snow or ice, a differentiating characteristic is that intended loads typically occur as sudden changes in weight, e.g., a person entering or exiting the vehicle, a piece of cargo being loaded or unloaded, or a trailer being joined to or removed from the vehicle. In contrast, accumulation of snow or ice tends to occur gradually over time (e.g., as falling snow builds up on vehicle surfaces or as snow and ice are projected onto the vehicle undercarriage during driving). In plot 30, sudden increases 31 and 32 in the weight correspond to loading of payload and then an occupant. At the end of a drive cycle, the weight drops at 33 when the cargo and occupant are removed. In a next drive cycle, after some sudden weight increases, a baseline weight 34 is maintained. Subsequently, a snow/ice accumulation event begins and the total weight begins to climb at 35. When the gradually increased weight rises to a total weight differential greater than a threshold 36, then it can be is determined that the accumulated snow and ice may result in an impairment of the driving range which is significant enough to merit taking corrective action.

By collecting sensor data such as measurements from ride height sensors and/or load cells, the invention monitors the electrified vehicle to determine the baseline weight which is propelled by the electrified vehicle. The collected data includes times prior to exposure to conditions in which frozen water can accumulate. As a next step, the invention determines an ambient temperature to which the electrified vehicle is exposed, and if the ambient temperature is less than a predetermined temperature threshold then the invention performs an environmental assessment to determine whether the electrified vehicle is subjected to accumulation of frozen water. Such an environmental assessment may include parameters such as outside ambient temperature, location of the vehicle (e.g., outside or in a garage), and current or potential future precipitation (e.g., snow, sleet, freezing rain) obtained by an offboard weather forecast or onboard sensors such as a camera.

If the electrified vehicle is subjected to accumulation of frozen water then the invention estimates a frozen water weight carried by the electrified vehicle in excess of the baseline weight. A range impairment according to the estimated frozen water weight is estimated. If the estimated range impairment is in a first zone of impairment then a mild warning is provided to a user of the electrified vehicle indicating a first loss of driving range due to the frozen water weight. If the estimated range impairment is in a second zone of impairment greater than the first zone of impairment then identifying a facility is identified which is configured to supply energy which melts the frozen water and an urgent warning is provided to the user indicating a second loss of driving range due to the frozen water weight and recommending that the electrified vehicle visit the identified facility.

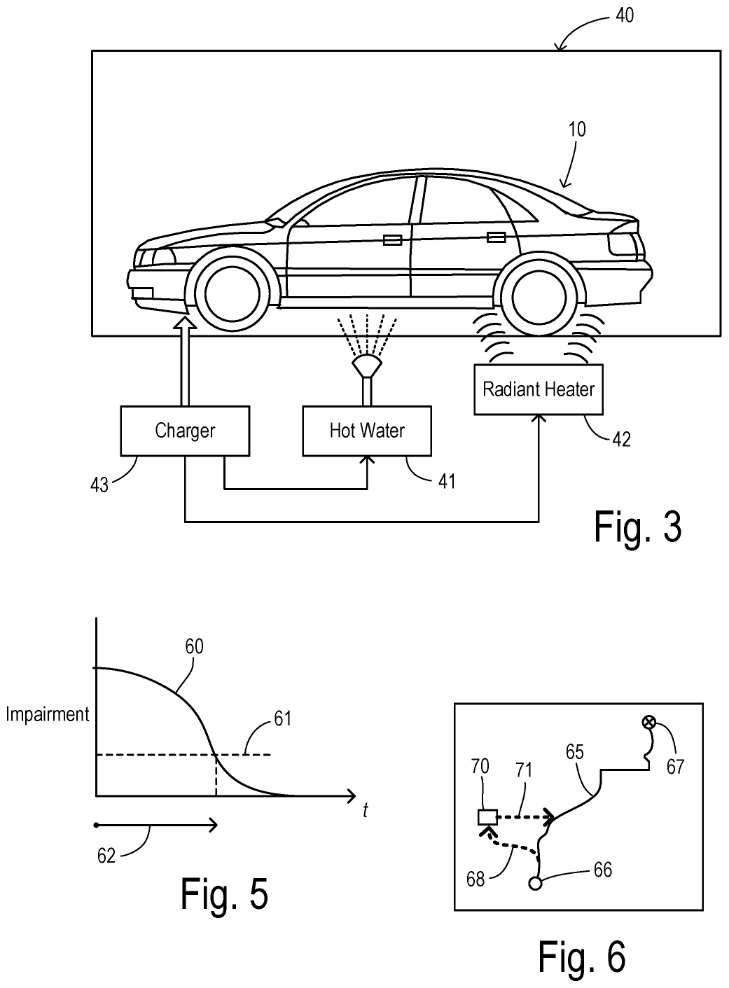

FIG. 3 shows vehicle 10 at a facility 40 where the accumulated snow and ice may be removed. Facility 40 may simply be a heated garage where vehicle 10 can be left for a sufficient time to perform the melting. To hasten the melting, facility 40 may include a hot water sprayer 41 and/or a radiant heater 42. In some embodiments, facility 40 may also include a battery charger 43 for coupling with vehicle 10. Electrical power from charger 43 may be utilized to power hot water sprayer 41 and/or radiant heater 42, either directly or through the electrical systems of vehicle 10. Since energy from charger 43 (or any other source within facility 40) is used to obtain the melting, a driving range of vehicle 10 can be extended during recharging without reducing the energy stored in vehicle 10.

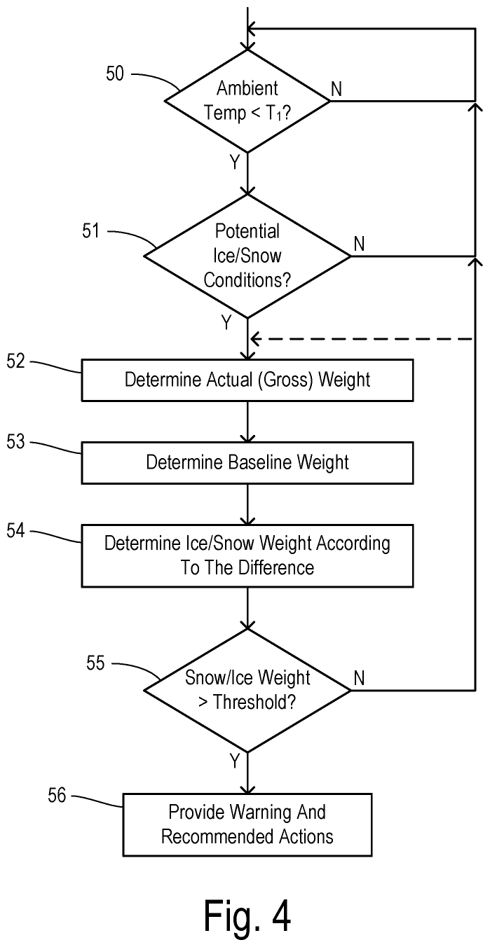

FIG. 4 shows one preferred method that may be performed during each new drive cycle, and portions of which may be performed continuously even while the vehicle is parked outdoors. In step 50, an outside ambient temperature is obtained and compared with a cold temperature threshold T₁. If the ambient temperature is less than T₁ then a check is performed in step 51 to determine whether there is a potential for accumulation of ice or snow. For example, if the vehicle is parked inside a garage then there may be no potential for accumulation. On the other hand, if the vehicle is parked outside or is being driven then this check may include examining current data (e.g., camera data or weather data) current or recent precipitation and reviewing future data (e.g., weather forecasts) to evaluate the potential. If no potential for frozen water conditions is found then the method returns to step 50. Otherwise, an actual gross vehicle weight (i.e., vehicle mass, cargo mass, trailer mass, and frozen water mass) is determined in step 52. A baseline weight of all the things which it is desired to propel with the vehicle (i.e., the weight which excludes the frozen water weight) is determined in step 53. In step 54, the weight of ice and snow is determined according to the difference between the weights from steps 52 and 53.

In step 55, the frozen water weight is compared to a warning threshold representing a weight that imposes a loss of range severe enough to warrant corrective measures. If the threshold has not been reached, then the method returns to step 50 or optionally to step 52. If the threshold is exceeded, then a warning and any recommended actions are provided to the driver in step 56.

In some embodiments, the warning threshold may be determined in terms of a range impairment which results from the accumulated frozen water weight. Furthermore, the method make take into account the possibility for accumulated snow or ice spontaneously leaving the vehicle (via melting or blowing off from wind or is vibration) at the beginning of a drive cycle so that a warning is not generated when the extra weight can be expected to resolve itself. More specifically, estimating the range impairment may include a prediction of spontaneous loss of the frozen water as shown in FIG. 6 wherein a plot 60 shows a declining range impairment as a vehicle begins to drive and the accumulated ice and snow diminishes while driving. The prediction of spontaneous loss may be determined in response to a weather forecast including a time-dependent ambient temperature factor (e.g., a predicted temperature rise during the day). Eventually the plotted impairment 60 drops to a value of a threshold 61, which represents an impairment level not requiring any corrective action. If an elapsed time 62 is sufficiently short, then the aggregated impact on the actual drivable range may be small. Thus, if an integral of plot 60 over elapsed time 62 is sufficiently small, then a warning or corrective action may be omitted.

The recommended actions in step 56 can include suggestions to park in a garage, brush snow off of top-hat surfaces, or proceed to a facility which has equipment configured to melt or otherwise remove the accumulated frozen water. The vehicle may consult a facility database (stored onboard and/or offboard) to find a closest or more convenient facility to which to proceed. A current location and/or a planned route to a destination may be obtained from a vehicle navigation system (e.g., a GPS based system). As shown in FIG. 6, a vehicle has a planned route 65 between a current location 66 and a destination 67. A facility 70 capable of melting ice and snow from the vehicle is listed in a facility database. Before recommending a detour to facility 70, the incremental total distance travelled represented by detour segments 68 and 71 can be compared to the range extension to be gained by removal of the weight of frozen water considering the trip to destination 67. For example, a step of choosing of the facility for a recommendation may include a comparison of an increased distance range to be obtained from melting the frozen water with a detour distance added to a current drive of the electrified vehicle by detouring to the facility.

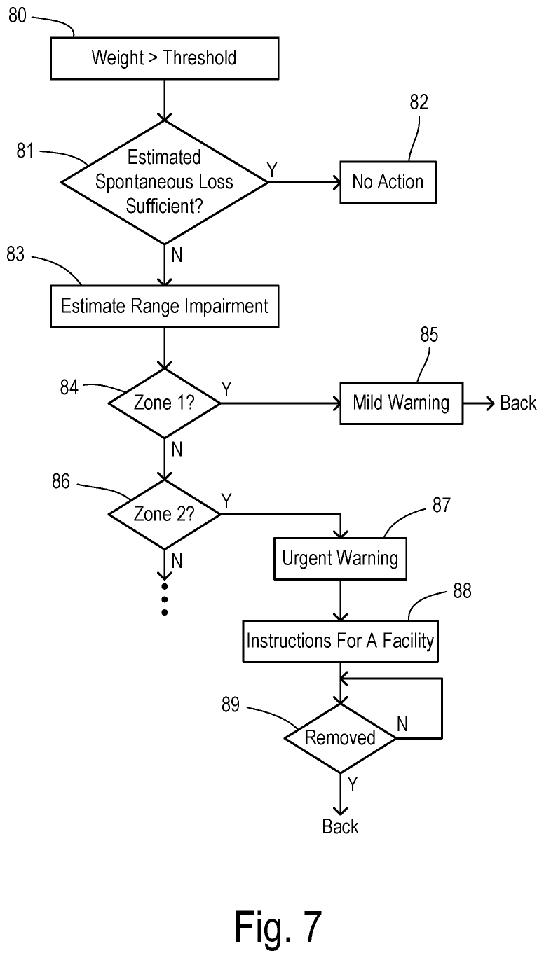

FIG. 7 shows a further embodiment of a method of the invention wherein the accumulated frozen water weight has been found to exceed a threshold at step 80. In step 81, a check is performed to determine whether an ambient temperature forecast is or other environmental or driving conditions may lead to an estimated spontaneous loss of frozen water weight which is sufficient to negate a need for a warning or automatic or a recommendation for corrective measures. If the spontaneous loss is sufficient then no action is taken and the method ends at step 82. Otherwise, a range impairment is estimated in step 83. A check is performed in step 84 to determine whether the estimated range impairment is in a first zone (Zone 1) of impairment in a range between a first (lower) threshold and a second (higher) threshold. If so, then a mild warning is provided to a user of the electrified vehicle in step 85 and then the method returns to a beginning of the process (e.g., back to step 50 in FIG. 4). The mild warning indicates a first loss of driving range due to the frozen water weight, allowing the user/driver to decide whether any changes to their driving plans are desired.

If not in the first zone, a check is performed in step 86 to determine whether the estimated range impairment is in a second zone (Zone 2) of impairment greater than the first zone of impairment (e.g., anything higher than the second threshold). In some embodiments, more than two zones of impairment can be employed, in which case the second zone is in a range between the second threshold and a third (higher) threshold. If impairment is in the second zone then an urgent warning is provided to the user in step 87 indicating a second loss of driving range due to the frozen water weight. In addition, a facility is identified which is configured to supply energy which melts the frozen water and a recommendation is provided to the driver (e.g., a message generated over an HMI) in step 88 with instructions for the electrified vehicle to visit the identified facility.

During the time spent melting the frozen water at the facility, the remaining weight of frozen water may be continuously monitored in step 89 (e.g., using onboard sensors such as ride height sensors or load cells). Monitoring of the melting is comprised of re-estimating the frozen water weight. Monitoring may continue in step 89 until the remaining weight drops below a predetermined threshold. Once sufficiently removed, the energy being supplied to melt the ice and snow may be terminated and the driver is notified that the process is completed.

The foregoing description relates to embodiments mainly applied to electric vehicles for road use, but the invention is equally applicable to electric carts, unmanned robotic vehicles (e.g., food delivery robots), airport tarmac support vehicles, fire trucks, or other special purpose electrified vehicles used in cold conditions. Additional embodiments may apply the invention to Internal Combustion Engine (ICE) vehicles where frozen water can accumulate in areas that may not spontaneously receive adequate heating from the ICE engine or exhaust system. This may be particularly true for large ICE vehicles such as a commercial van, bus, or limousine.

Besides frozen water (ice and snow), other types of road debris can also attach and accumulate under a vehicle. For example, mud and dirt could likewise accumulate on vehicles (including electrified and hybrid vehicles), especially for drivers frequently using unpaved roads. The invention can also be used to detect, track, warn, and remove accumulations of mud and dirt.

What is claimed is:

1. A method of operating an electrified vehicle, comprising the steps of:
monitoring the electrified vehicle to determine a baseline weight which is propelled by the electrified vehicle;
determining an ambient temperature to which the electrified vehicle is exposed;
if the ambient temperature is less than a predetermined temperature threshold then performing an environmental assessment to determine whether the electrified vehicle is subjected to accumulation of frozen water;
if the electrified vehicle is subjected to accumulation of frozen water then:
(A) estimating a frozen water weight carried by the electrified vehicle in excess of the baseline weight;
(B) estimating a range impairment according to the estimated frozen water weight;
(C) if the estimated range impairment is in a first zone of impairment then providing a mild warning to a user of the electrified vehicle indicating a first loss of driving range due to the frozen water weight; and
(D) if the estimated range impairment is in a second zone of impairment greater than the first zone of impairment then (i) identifying a facility which is configured to supply energy which melts the frozen water and (ii) providing an urgent warning to the user indicating a second loss of driving range due to the frozen water weight and recommending that the electrified vehicle visit the identified facility.

2. The method of claim 1 wherein the step of estimating the range impairment includes a prediction of spontaneous loss of the frozen water.

3. The method of claim 2 wherein the prediction of spontaneous loss is responsive to a weather forecast including a time-dependent ambient temperature factor.

4. The method of claim 1 wherein identifying the facility is comprised of examining a predetermined list of facilities providing apparatus which is configured for spraying heated water onto the electrified vehicle.

5. The method of claim 1 wherein identifying the facility is comprised of examining a predetermined list of facilities providing apparatus which is configured for radiating heat onto the electrified vehicle.

6. The method of claim 1 further comprising the steps of:
relocating the electrified vehicle to the facility; and
exposing the electrified vehicle to the supplied energy.

7. The method of claim 6 further comprising the steps of:
monitoring a progress of melting of the frozen water; and
terminating the supplied energy when the progress reaches a predetermined threshold.

8. The method of claim 7 wherein the monitoring of progress is comprised of re-estimating the frozen water weight.

9. The method of claim 6 further comprising the step of recharging a battery of the electrified vehicle while the electrified vehicle is being exposed to the supplied energy.

10. The method of claim 1 wherein the identifying of the facility includes a comparison of an increased distance range to be obtained from melting the frozen water with a detour distance added to a current drive of the electrified vehicle by detouring to the facility.

11. The method of claim 1 wherein the baseline weight includes a cargo loaded on the electrified vehicle and a weight of a trailer being towed by the electrified vehicle.

12. The method of claim 1 wherein the environmental assessment is comprised of capturing image data using a camera to detect frozen water on or nearby the electrified vehicle.

13. The method of claim 1 wherein the environmental assessment is comprised of accessing a weather forecast.

14. An electrified vehicle comprising:
a load monitoring device configured to determine a baseline weight which is propelled during movement of the electrified vehicle not including any frozen water which may be carried by the electrified vehicle;
an ambient temperature sensor determining an ambient temperature to which the electrified vehicle is exposed; and
a controller configured to perform an environmental assessment whether the electrified vehicle is subject to accumulation of frozen water whenever the ambient temperature is less than a predetermined temperature threshold;
wherein when the electrified vehicle is subject to accumulation of frozen water then the controller further:
(A) estimates a frozen water weight carried by the electrified vehicle in excess of the baseline weight;
(B) estimates a range impairment according to the estimated frozen water weight;
(C) if the estimated range impairment is in a first zone of impairment then provides a mild warning to a user of the electrified vehicle indicating a first loss of driving range due to the frozen water weight; and
(D) if the estimated range impairment is in a second zone of impairment greater than the first zone of impairment then (i) identifies a facility which is configured to supply energy which melts the frozen water and (ii) provides an urgent warning to the user indicating a second loss of driving range due to the frozen water weight and recommending that the electrified vehicle visit the identified facility.

15. The electrified vehicle of claim 14 further comprising a camera configured to capture image data used in the environmental assessment, wherein the image data is analyzed to detect frozen water on or nearby the electrified vehicle.

16. The electrified vehicle of claim 14 further comprising a wireless transceiver configured to access a weather forecast used in the environmental assessment.

17. The electrified vehicle of claim 14 wherein the controller is further configured to estimate the range impairment using a prediction of spontaneous loss of the frozen water.

18. The electrified vehicle of claim 17 wherein the prediction of spontaneous loss is responsive to a weather forecast including a time-dependent ambient temperature factor.

19. The electrified vehicle of claim 14 wherein identifying the facility is comprised of examining a predetermined list of facilities providing apparatus which is configured for spraying heated water onto the electrified vehicle.

20. The electrified vehicle of claim 14 wherein the load monitoring device is comprised of a ride height sensor.
